(19) United States
(12) Patent Application Publication
(10) Pub. No.: US 2008/0162271 A1
(43) Pub. Date: Jul. 3, 2008

(54) GIFT CARD SHARING IN A CUSTOM MERCHANDISE ENVIRONMENT

(75) Inventor: Yobie Benjamin, Fremont, CA (US)

Correspondence Address: Intellevate, P.O. Box 52050, Minneapolis, MN, 55402, US

(73) Assignee: Zazzle, Inc., Menlo Park, CA (US)

(21) Appl. No.: 11/967,734

(22) Filed: Dec. 31, 2007

Related U.S. Application Data
(60) Provisional application No. 60/878,001, filed on Dec. 29, 2006.

(51) Int. Cl. G06Q 30/00

(52) U.S. Cl. 705/10; 705/26

(57) ABSTRACT

A method and system a gift card sharing in a custom merchandise environment. In one embodiment, a method includes providing a product template having a region in which customization is allowable, applying a design of a creator user in the region, generating a set of parameters in which further customization is allowable in the region based on a preference of the creator user, constraining the design to the product template, generating a gift card associated with the product template having the design in the region, communicating the gift card to a recipient user and generating an interface that enables the recipient user to further customize the design in the region of the product template based on the set of parameters defined by the creator user. The method may further include processing a payment provided by the creator user when purchasing the gift card.

### CLAIM OF PRIORITY

This application claims priority form the Provisional application 60/878,001 titled “Redeemable Online Gift Card Associated With A Customizable T-Shirt Design” filed on Dec. 29, 2006.

### FIELD OF TECHNOLOGY

This disclosure relates generally to the technical fields of software and/or hardware technology and, in one example embodiment, to a gift card sharing in a custom merchandise environment.

### BACKGROUND

A website (e.g., Zazzle.com®, Cafepress®.com, etc.) may enable a creator user (e.g., a user who produces through artistic and/or imaginative effort) to customize an item (e.g., a t-shirt, a holiday card, a button, a poster, a mug, a postage stamp, etc.) of merchandise. The creator user may wish to share the item of customized merchandise with a recipient user (e.g., a friend, a colleague, a member of an organization, a family member, etc.). The creator user may wish for the recipient user to further customize the item of merchandise. Furthermore, the creator user may wish to collaborate (e.g., work jointly) with the recipient user in the customization of the item of merchandise. However, to enable this, the creator user may be uncomfortable with sharing a password to access the website with the recipient user (e.g., because of security and privacy concerns).

Furthermore, the creator user may wish to surprise the recipient user with a gift (e.g., give voluntarily without payment in return, as to show favor toward, honor an occasion, etc.). The creator user may need to post the item (e.g., list the item in a category of products) on the website and tell the recipient user to manually search for and locate the item of merchandise through an offline mechanism (e.g., phone, in face-to-face conversation, etc.).

The recipient user may have difficulty finding the item of merchandise on the website because there may be numerous items having similar descriptions. Even when the recipient user finds the item, the creator user may not be able to constrain the degree of customization allowable of the item of merchandise. As a result, numerous custom merchandise sales opportunities may be lost.

### SUMMARY

A method apparatus and system of a gift card sharing in a custom merchandise environment is disclosed. In one aspect, a method includes providing a product template (e.g., may include an apparel template, a mug template, a t-shirt template, a poster template, a virtual gift template, a postage template, a greeting card template, a calendar template, a button template and/or a print template) having a region in which customization is allowable, applying a design of a creator user in the region, generating a set of parameters (e.g., may include a region surrounding the design, a portion of the design itself and/or a color scheme of the product template) in which further customization is allowable in the region based on a preference of the creator user, constraining the design to the product template, generating a gift card associated with the product template having the design in the region, communicating the gift card to a recipient user and generating an interface that enables the recipient user to further customize the design in the region of the product template based on the set of parameters defined by the creator user.

The product may embody further customization defined by the recipient user when the further customization adheres to the set of parameters defined by the creator user. The method may include processing a payment provided by the creator user when purchasing the gift card, applying the payment toward a redeemable value (e.g., may include shipping and/or handling of the product to a destination defined by the recipient user) of the gift card, providing the gift card to the recipient user based on a request of the creator user and enabling the recipient user to apply the redeemable value toward purchase of a product having the design of the creator user.

The method may include requiring the recipient user to perform task prior to redeeming the value of the gift card. The task may be designed by the creator user when providing the gift card to the recipient user and the task may be a questionnaire response, a survey response, an item purchase and/or a coupon redemption.

In addition, the method may include enabling the recipient user to apply a required portion of the value of the gift card (e.g., may be distributable as a widget embedded in a plurality of blogs and social networking websites defined by the creator user, the recipient user and/or the other recipients) toward the purchase of the product when a price of the product is less than the value of the gift card and subdividing a remaining portion of the value of the gift card among a group of other recipients selected by the recipient user when such a capability is permitted by the creator user.

The method may also include applying a limited time duration in which the gift card is redeemable by the recipient user and enabling the recipient to apply the value of the gift card as points in the blogs and social networking websites. The method may also include applying the design in a representation the gift card such the design is reflected in a communication of the gift card to the recipient.

In another aspect, a method includes creating a gift card that is applicable to a purchase of custom merchandise products, constraining a redeem ability of the gift card to a set of products as defined by a sender of the gift card, communicating the gift card to a recipient based on a selection of the sender, permitting both the sender and the recipient to customize the set of products and permitting the recipient to purchase the set of products embodying joint customization of the sender and the recipient. The customizations defined by the sender may take precedence over customizations of the recipient such that customizations by the recipient are constrained by the customizations of the sender.

In addition, the method may include applying a value to the gift card based on a purchase amount of the gift card by the sender, permitting the recipient to subdivide a value of the gift card such that other recipients selected by the sender and/or recipient have an ability to redeem an available balance of the gift card through a purchase of additional ones of the custom merchandise products. The method may also include creating an embeddable representation of the gift card such that the embeddable representation is distributable across affiliate websites within a duration of time specified by the sender of the gift card.

In yet another aspect, a system includes a custom merchandise module to generate a set of product templates representing virtual and physical items that are customizable in a region defined in each of the set of product templates, a gift card module of the custom merchandise module to provide a mechanism such that users of the custom merchandise module provide consideration to other users to procure the virtual and physical items of the custom merchandise module and a constraint module of the gift card module to limit a degree in which the other users are permitted to further customize the set of product templates prior to procuring the virtual and physical items represented in the set of product templates.

In addition, the system may include a desegregation module of the gift card module to provide an interface such that the other users have an ability to redistribute a portion of a value of the gift card to at least one other user, such that users other than the users providing consideration to procure the virtual and physical items through the gift card are constrained in further customization through the constraint module.

The system may also include a ship include module of the gift card module to provide a value of transporting the physical items to a physical destination specified by a procuring user as included in the gift card. The system may further include a widget module to distribute the gift card across different distribution mediums based on a preference of users sending and receiving the gift card. In addition, the system may include a system constraint module of the constraint module to impose limitations based on an availability, a stock level and/or a lead time of the virtual and physical items.

The methods, systems, and devices disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A is a system view of a custom merchandise module having a gift card module associated with at least one client device, according to one embodiment.

FIG. 1B is a product template view along with the set of parameters, according to one embodiment.

FIG. 1C is a gift card view, according to one embodiment.

FIG. 2 is an exploded view of the gift card module, according to one embodiment.

FIG. 3 is a table view of details associated with the creator user related to the set of products in a custom merchandise environment, according to one embodiment.

FIG. 4 is a user interface view 450 of customizing a gift card, according to one embodiment.

FIG. 5 is a process flow view of sending a gift card to the recipient user 110 along with the customized designed product, according to one embodiment.

FIG. 6 is a process flow view of managing the value, according to one embodiment.

FIG. 7 is a diagrammatic system view 750 of a data processing system in which any of the embodiments disclosed herein may be performed, according to one embodiment.

FIG. 8A is a process flow communicating the gift card having a product template to a recipient user, according to one embodiment.

FIG. 8B is a continuation of the process flow of FIG. 8A showing additional process, according to one embodiment.

FIG. 8C is a continuation of the process flow of FIG. 8B showing additional process, according to one embodiment.

FIG. 9 is a process flow of communicating the gift card having embedded design and a value that may be distributable across affiliate websites within a specified duration of time, according to one embodiment.

Other features of the present embodiments will be apparent from the accompanying drawings and from the description that follows.

### DETAILED DESCRIPTION

A method apparatus and system of a gift card sharing in a custom merchandise environment is disclosed. In the following description, for the purposes of explanation, numerous specific details are set forth in order to provide a thorough understanding of the various embodiments. It will be evident, however to one skilled in the art that the various embodiments may be practiced without these specific details.

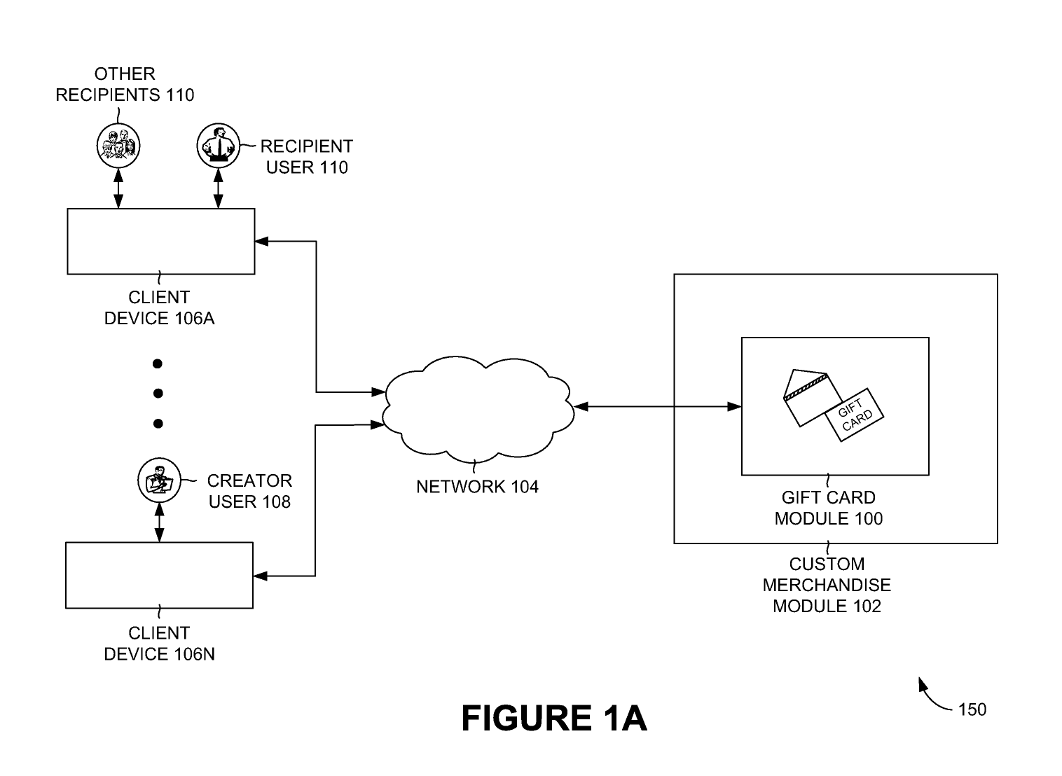

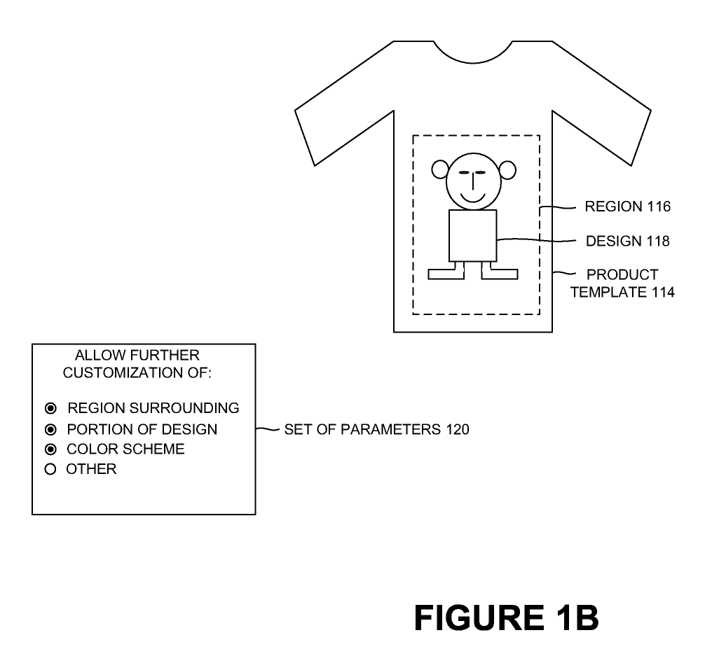

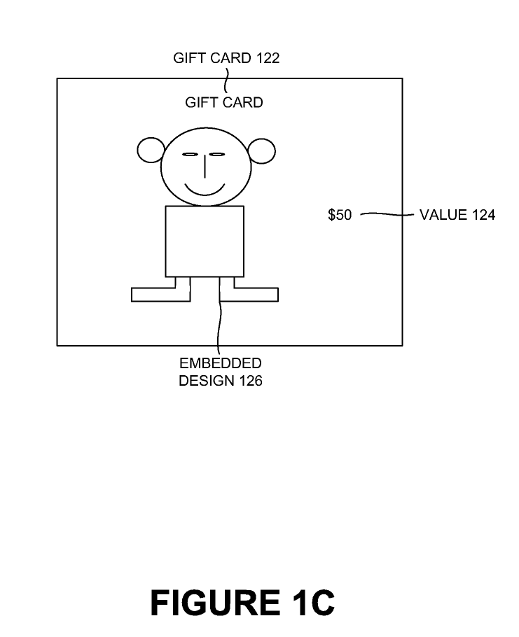

In one embodiment, a method includes providing a product template (e.g., the product template 114 of FIG. 1A) having a region (e.g., the region 116 of FIG. 1B) in which customization is allowable, applying a design (e.g., the design 118 of FIG. 1B) of a creator user (e.g., the creator user 108 of FIG. 1A) in the region 116, generating a set of parameters (e.g., the set of parameters 120 of FIG. 1B) in which further customization is allowable in the region 116 based on a preference of the creator user 108, constraining the design 118 to the product template 114, generating a gift card (e.g., the gift card 122 of FIG. 1C) associated with the product template 114 having the design 118 in the region 116, communicating the gift card 122 to a recipient user 110 and generating an interface that enables the recipient user 110 to further customize the design 118 in the region 116 of the product template 114 based on the set of parameters 120 defined by the creator user 108.

In another embodiment, a method includes creating a gift card 122 that is applicable to a purchase of custom merchandise products, constraining a redeem ability of the gift card 122 to a set of products as defined by a sender of the gift card 122, communicating the gift card 122 to a recipient based on a selection of the sender, permitting both the sender and the recipient to customize the set of products and permitting the recipient to purchase the set of products embodying joint customization of the sender and the recipient.

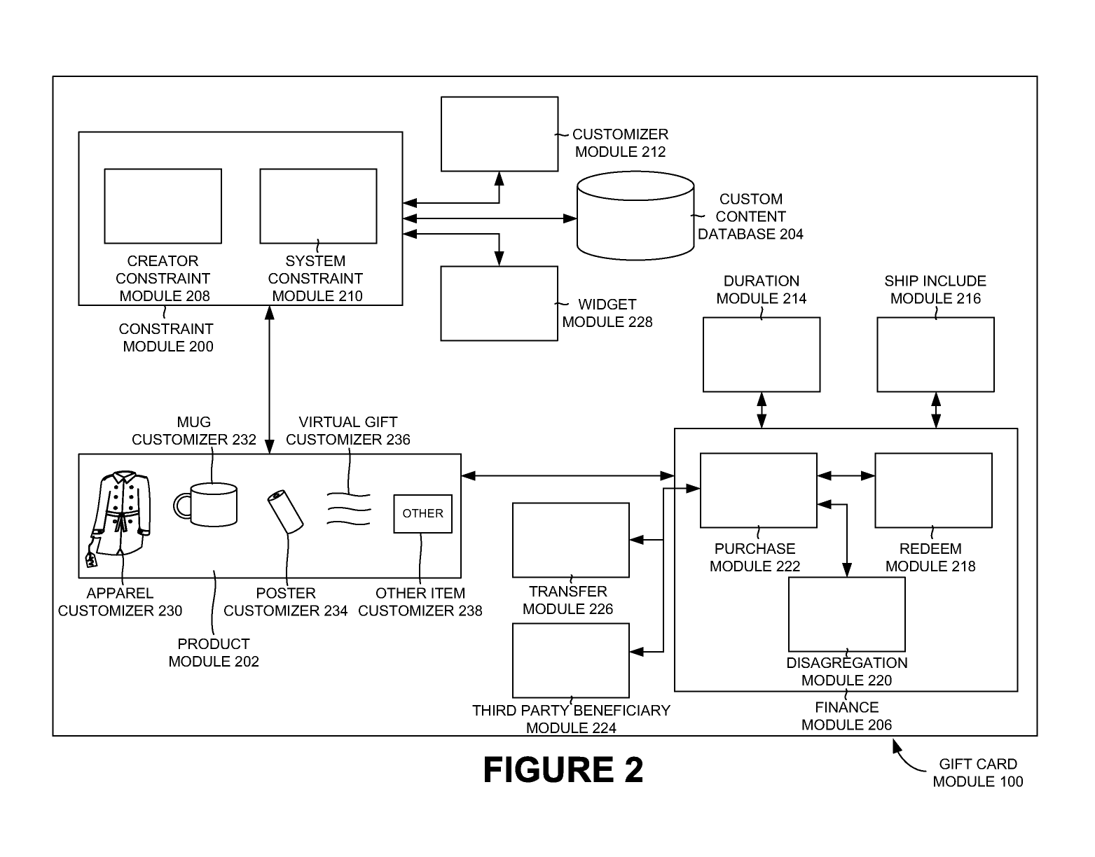

In yet another embodiment, a system includes a custom merchandise module (e.g., the custom merchandise module 102 of FIG. 1A) to generate a set of product templates 114 representing virtual and physical items that are customizable in a region 116 defined in each of the set of product templates 114, a gift card module (e.g., the gift card module 100 of FIG. 1A) of the custom merchandise module 102 to provide a mechanism such that users of the custom merchandise module 102 provide consideration to other users to procure the virtual and physical items of the custom merchandise module 102 and a constraint module (e.g., the constraint module 200 of FIG. 2) of the gift card module 100 to limit a degree in which the other users are permitted to further customize the set of product templates 114 prior to procuring the virtual and physical items represented in the set of product templates 114.

FIG. 1A is a system view of a custom merchandise module 102 having a gift card module 100 associated with at least one client device 106, according to one embodiment. Particularly, FIG. 1A illustrates a gift card module 100, a custom merchandise module 102, a network 104, client devices 106A-N, a creator user 108, a recipient user 110 and other recipients 112, according to one embodiment.

The gift card module 100 may provide a mechanism such that users of the custom merchandise module 102 provide consideration to other users to procure the virtual and physical items of the custom merchandise module 102. The custom merchandise module 102 may generate a set of product templates 114 representing virtual and physical items that are customizable in a region 116 defined in each of the set of product templates 114.

The network 104 (e.g., Internet, wireless Internet, WAN, LAN, Bluetooth, Wi-Fi, Wi-Max, telecommunications, radio frequency and/or infrared network, etc.) may enable communication between the creator user 108, the recipient user 110 and the other recipients 112. The client devices 106A-N may enable the creator user 108 to share the product template 114 having a design 118 in the region 116 with the recipient user 110.

The creator user 108 may have specific users to whom he desires to share designs of a set of products of custom merchandise. For example, the creator users 108 may include tailors, fashion designers and/or artists. The recipient user 110 may be registered users and/or unregistered users who desires to purchase the custom merchandise products. For examples, the recipient user 110 may include patrons, fans, followers, observers, buyers, customers who interact with the creator users 108 to purchase the set of products of custom merchandise. The other recipients 112 may include other users selected by the recipient user 110 who receives the gift card 122.

In the example embodiment illustrated in FIG. 1A, the custom merchandise module 102 may interact with the client devices 106A-N through the network 104. The recipient user 110 and other recipients 112 may communicate with the client device 106A and the creator user 108 communicates with the client device 106N. The custom merchandise module 102 may include the gift card module 100.

In one embodiment, the gift card (e.g., the gift card 122 of FIG. 1C) associated with the product template (e.g., the product template 114 of FIG. 1B) may be generated having the design (e.g., the design 118 of FIG. 1B) in the region (e.g., the region 116 of FIG. 1B). The gift card 122 may be communicated to a recipient user 110. An interface may be generated that enables the recipient user 110 to further customize the design 118 in the region 116 of the product template 114 based on the set of parameters 120 defined by the creator user 108. The gift card 122 may be created (e.g., using the gift card module 100 of FIG. 1A) that is applicable to a purchase of custom merchandise products.

FIG. 1B is a product template view along with the set of parameters 120, according to one embodiment. Particularly, FIG. 1B illustrates a region 116, a design 118, a product template 114 and the set of parameters 120, according to one embodiment.

The region 116 may be an area on the product template 114 where the creator user 108 can materialize his creativity in a form of the design 118. The design 118 is the materialization of an idea of the creator user 108 using appropriate shapes, sizes, colors, etc. within the given region 116 of the product template 114. The product template 114 may be a template of various products (e.g., Men's T-Shirts, Women's T-Shirts, Cards, Postage, Posters, Mugs, Hats, Aprons, Bags, Bumper Stickers, Buttons, Calendars Key chains, etc.) available for the creator user 108 to customize the product.

For example, the product template 114 may include an apparel template, a mug template, a t-shirt template, a poster template, a virtual gift template, a postage template, a greeting card template, a calendar template, a button template, a print template, etc. The product template 114 may consist of a region 116 in which the creator user 108 can apply his creativity to create a design 118 using various set of designing tools. The set of parameters 120 may be an option selected by the creator user 108 in which further customization is allowed on the product template 114.

In the example embodiment illustrated in FIG. 1A, the product template view may display a T-shirt template having the region 116 where the creator user 108 designs on real models in his profile. The creator user 108 may select from a wide variety of custom cuts and styles, and then manipulate the images to create his own, one-of-a-kind shirt.

In one embodiment, the product template 114 may be provided having a region 116 in which customization is allowable. The design 118 of the creator user 108 may be applied in the region 116. The set of parameters 120 may be generated in which further customization is allowable in the region 116 based on a preference of the creator user 108. For example, the product template 114 may be an apparel template, a mug template, a t-shirt template, a poster template, a virtual gift template, a postage template, a greeting card template, a calendar template, a button template, a print template, etc.

FIG. 1C is a gift card view, according to one embodiment. Particularly, FIG. 1C illustrates a gift card 122, a value 124 and an embedded design 126, according to one embodiment. The gift card 122 may be a card in which the customized creation of the product template 114 is embedded along with the redeemable value provided by the creator user 108 to the recipient user 110. The value 124 may be the consideration provided to the recipient user 110 by the creator user 108 to redeem an available balance of the gift card 122 to make additional purchases of the product having the design of the creator user 108. The embedded design 126 may the design 118 created by the creator user 108.

In one embodiment, an embeddable representation of the gift card 122 may be created such that the embeddable representation is distributable across affiliate websites within a duration of time specified by the sender of the gift card 122.

FIG. 2 is an exploded view of the gift card module 100, according to one embodiment. Particularly, FIG. 2 illustrates a constraint module 200, a product module 202, a custom content database 204, a finance module 206, a creator constraint module 208, a system constraint module 210, a customizer module 212, a duration module 214, a ship include module 216, a redeem module 218, the disagregation module 220, a purchase module 222, a third party beneficiary module 224, a transfer module 226, a widget module 228, an apparel customizer 230, a mug customizer 232, a poster customizer 234, a virtual gift customizer 236 and an other item customizer 238, according to one embodiment.

The constraint module 200 may limit a degree in which the other users are permitted to further customize the set of product templates 114 prior to procuring the virtual and physical items represented in the set of product templates 114. The product module 202 may provide the set of product template 114 having a region 116 in which customization is allowable. For example, the product template 114 may be an apparel template, a mug template, a t-shirt template, a poster template, a virtual gift template, a postage template, a greeting card template, a calendar template, a button template, and a print template.

The custom content database 204 may include a set of products, content related to the creative users 108, the recipient users 110, other recipient users 112 and also design tools to design 118 the product. The finance module 206 may process a payment provided by the creator user 108 when purchasing the gift card 122 and apply the payment toward a redeemable value of the gift card 122. The creator constraint module 208 may impose limitations based on kind of product, the region 116 where customization is allowable on the product template 114 and the design tool availability. The system constraint module 210 may impose limitations based on availability, a stock level, and a lead time of the virtual and physical items.

The customizer module 212 may permit the creative user 108 and the recipient user 110 to customize the set of products (e.g., t-shirt, mug, greeting card, hats, key chains, magnets, bags, ties, etc.) prior to procuring the virtual and physical items by the recipient user 110. The duration module 214 may allow the creator user 108 to apply limited time duration to the gift card 122 which is provided to the recipient user 110 so that the recipient user 110 redeems the value 124 of the gift card 122.

The ship include module 216 may provide a value 124 of transporting the physical items to a physical destination specified by a procuring user as included in the gift card 122. The redeem module 218 may apply the payment provided by the creator user 108 toward a redeemable value of the gift card 122. For example, the redeemable value may include shipping and handling of the product to a destination defined by the recipient user 110. The disagregation module 220 may provide an interface such that the other users have an ability to redistribute a portion of a value 124 of the gift card 122 to another user, such that users other than the users providing consideration to procure the virtual and physical items through the gift card (e.g., the gift card 122 of FIG. 1) are constrained in further customization through the constraint module 200.

The purchase module 222 may enable the recipient user 110 to purchase a product having the design 118 of the creator user 108. The third party beneficiary module 224 may enable distribution of the gift card 122 across a number of affiliate website. The transfer module 226 may enable subdividing the value of the gift card 122 among a group of other recipients 112 selected by the recipient user 110 when such a capability is permitted by the creator user 108. The widget module 228 may distribute the gift card 122 across any number of different distribution mediums based on a preference of users sending and receiving the gift card 122.

The apparel customizer 230 may permit the creative user 108 and the recipient user 110 to customize the apparel (e.g., men's T-shirts, women's T-shirts, cloths, dress, outfit, garments, etc.) from a wide variety of custom cuts and styles available on the website. The mug customizer 232 may permit the creative user 108 and the recipient user 110 to customize a mug (e.g., cup, beaker, goblet, etc.) from a wide variety of custom design of various shape and sizes available on the website. The poster customizer 234 may permit the creative user 108 and the recipient user 110 to customize a poster (e.g., calendar, greeting card, postage, stickers, postcards, photo sculptures, bumper stickers, etc.) from a wide variety of design tools available on the website.

For example, the user can customize designs by dragging the images around the product by using the drag and drop design tools. The user can also explore the font collection with wide range of options, change colors, styles etc. The virtual gift customizer 236 may permit the creative user 108 and the recipient user 110 to customize a gift (e.g., t-shirt, mug, greeting card, hats, key chains, magnets, bags, ties, etc.) from a wide variety of custom cuts and styles available on the website. The other item customizer 238 may permit the creative user 108 and the recipient user 110 to customize a set of products from a wide range of products available on the website.

In the example embodiment illustrated in FIG. 2, the finance module 206 may communicate with the transfer module 226, the third party beneficiary module 224, the duration module 214, the ship include module 216 and the product module 202. The product module 202 may further communicate with the constraint module 200, the customizer module 212, the custom content database 204 and the widget module 228.

The constraint module 200 may include the creator constraint module 208 and the system constraint module 210. The product module 202 may include the apparel customizer 230, the mug customizer 232, the poster customizer 234, the virtual gift customizer 236 and the other item customizer 238. The finance module 206 may include the purchase module 222, the redeem module 218 and the disagregation module 220.

In one embodiment, the design (e.g., the design 118 of FIG. 1B) may be constrained to the product template (e.g., the product template 114 of FIG. 1B). A payment may be processed provided by the creator user (e.g., the creator user 108 of FIG. 1A) when purchasing the gift card (e.g., the gift card 122 of FIG. 1C). The payment may be applied toward the redeemable value (e.g., may include shipping and handling of the product to a destination defined by the recipient user) of the gift card 122 (e.g., the gift card may be distributable as a widget embedded in the blogs and social networking websites defined by the creator user 108, the recipient user 110 and the other recipients 112). The gift card 122 may be provided to the recipient user (e.g., the recipient user 110 of FIG. 1) based on a request of the creator user 108.

The recipient user 110 may be enabled to apply the redeemable value toward purchase of the product (e.g., the product embodies further customization defined by the recipient user 110 when the further customization adheres to the set of parameters 120 defined by the creator user 108) having the design 118 of the creator user 108. For example, the set of parameters 120 may include a region 116 surrounding the design 118, a portion of the design 118 itself, and a color scheme of the product template 114. The limited time duration may be applied in which the gift card 122 is redeemable by the recipient user 110.

The recipient may be enabled to apply the value (e.g., the value 124 of FIG. 1C) of the gift card 122 as points in the blogs and/or social networking websites. A redeem ability may be constrained of the gift card 122 to the set of products as defined by a sender of the gift card 122. The gift card 122 may be communicated to a recipient based on a selection of the sender. Both the sender and the recipient may be permitted to customize the set of products. The recipient may be permitted to purchase the set of products embodying joint customization of the sender and the recipient. For example, customizations defined by the sender may take precedence over customizations of the recipient such that customizations by the recipient are constrained by the customizations of the sender.

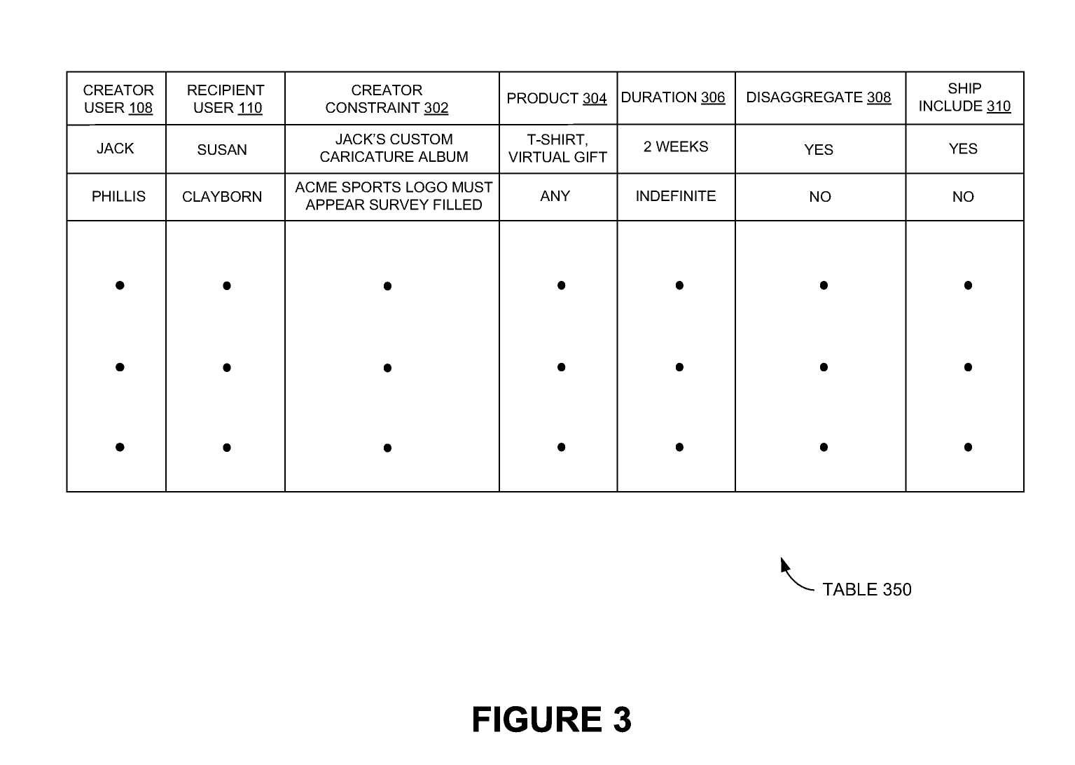

FIG. 3 is a table view of details associated with the creator user (e.g., the creator user 108 of FIG. 1) related to the set of products in a custom merchandise environment, according to one embodiment. Particularly, FIG. 3 illustrates a creator user field 108, a recipient user field 110, a creator constraint field 302, a product field 304, a duration field 306, a disaggregate field 308 and a ship include field 310, according to one embodiment.

The creator user field 108 may display the name of the creator user 108 in the custom merchandise environment. The recipient user field 110 may display the name of the recipient user 110 in the custom merchandise environment. The creator constraint field 302 may display the specifications related to the product preferred by the creator user 108.

The product field 304 may display the type of product (e.g., calendar, greeting card, postage, stickers, postcards, photo sculptures, bumper stickers, etc.) the recipient user 110 is willing to purchase from the custom merchandise. The duration field 306 may display the limited time duration specified by the creator user 108 of the gift card 122. The disaggregate field 308 may display an option selected by the creator user 108 to provide an interface such that other users have an ability to redistribute the value 124 of the gift card 122. The ship include field 310 may display an option selected by the creator user 108 to provide a value of transporting the physical items to a physical destination specified by a recipient user 110.

In the example embodiment illustrated in FIG. 3, the creator user field 108 displays “Jack” in the first row, “Phillis” in the second row, indicating the name of the creator user 108 in the custom merchandise environment in the creator user field column 108. The recipient user field 110 displays “Susan” in the first row, “Claybom” in the second row, indicating the name of the recipient user 110 in the custom merchandise environment in the recipient user field column 110.

The creator constraint field 302 displays “Jack's Custom Caricature Album” in the first row, “Acme Sports Logo must appear, Survey Filled” in the second row, indicating the specifications related to the product preferred by the creator user 108 in the creator constraint field column 302. The product field 304 displays “T-Shirt, Virtual Gift” in the first row, “Any” in the second row, indicating the type of product the recipient user 110 is willing to purchase from the custom merchandise in the product field column 304. The duration field 306 displays “2 weeks” in the first row, “Indefinite” in the second row, indicating the limited time duration specified by the creator user 108 of the gift card 122 in the duration field column 306.

The disaggregate field 308 displays “Yes” in the first row, “No” in the second row, indicating an option selected by the creator user 108 to provide an interface such that other users have an ability to redistribute the value 124 of the gift card 122 in the disaggregate field column 308. The ship include field 310 displays “Yes” in the first row, “No” in the second row, indicating an option selected by the creator user 108 to provide a value of transporting the physical items to a physical destination specified by a recipient user 110 in the ship include field column 310.

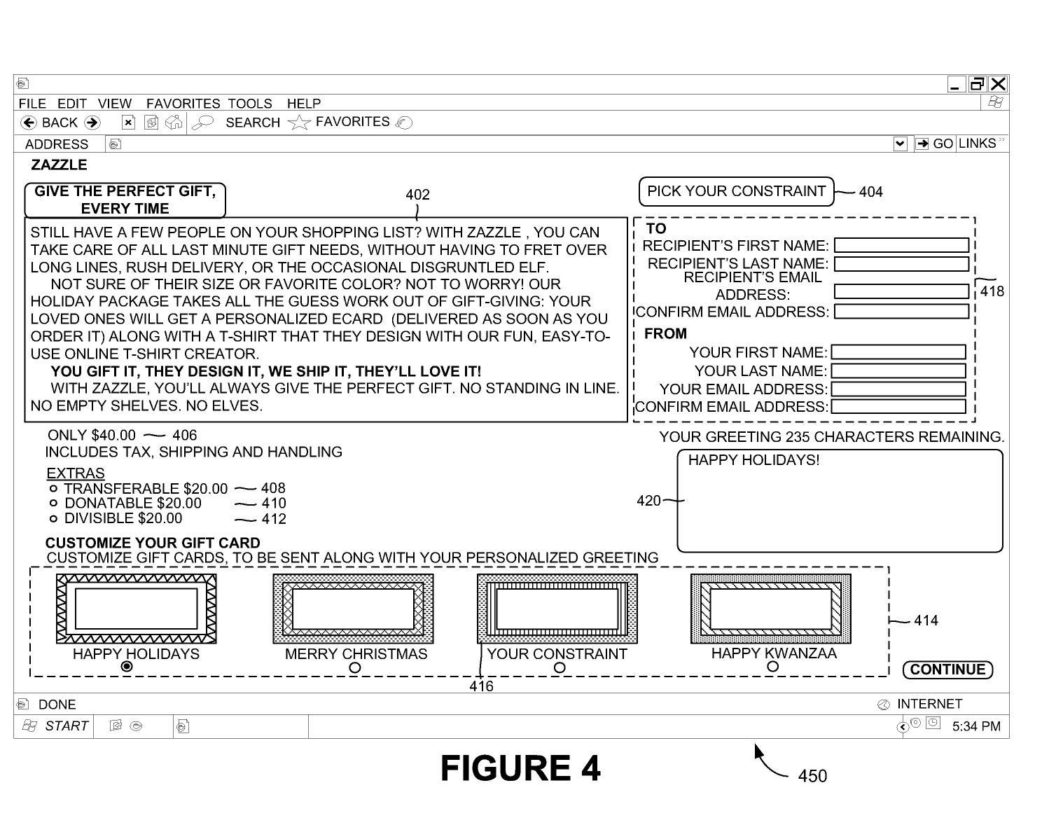

FIG. 4 is a user interface view 450 of customizing a gift card, according to one embodiment. Particularly, FIG. 4 illustrates block 402 and pick your constraint option 404, option 406, transferable value 408, donatable value 410, divisible value 412, options 414, your constraint card 416, address form 418 and message block 420 according to one embodiment.

The block 402 may be an advertising message displayed for the visitors who visit the webpage for purchasing a gift. Pick your constraint option 404 may be a button which enables the creator user 108 to pick the constraint of the choice defined by the creator user 108. The option 406 may be a total fee charged for the product which includes tax, shipping and/or handling. The transferable value 408 may be the value which can be used for transferring it to others. The donatable value 410 may be the value which can be used for donation purposes. The divisible value 412 may be the value which can be used to divide the gift card 122 to other recipients.

The option 414 may be the various options to allow the creator user 108 to select and customize the gift card. The your constraint card 416 may be the gift card 122 which is customized by the creator user 108. The address form 418 may be the form in which details of the creator user's 108 and the recipient user's 110 like first name, last name, email address along with the email address confirmation, etc will be entered. The message block 420 may be the place for the recipient user 110 to post a message as a personal wish sent to the gift receiver along with the gift.

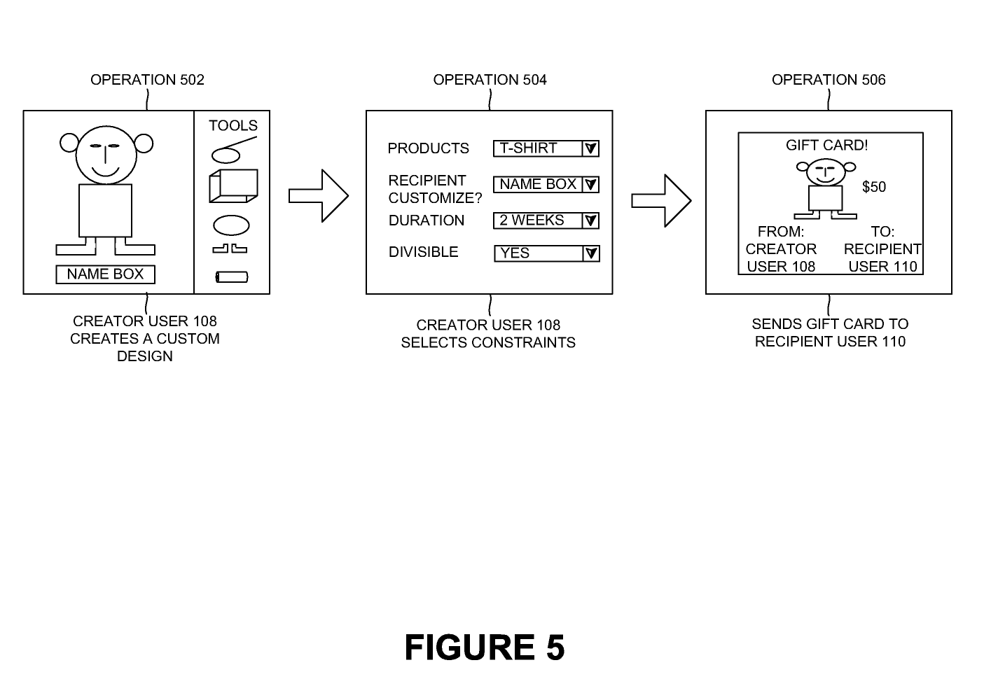

FIG. 5 is a process flow view of sending a gift card to the recipient user 110 along with the customized designed product, according to one embodiment. Particularly, FIG. 5 illustrates an operation 502, an operation 504 and operation 506, according to one embodiment.

The operation 502 may display a custom designed product created by the creator user 108 by selecting from a wide variety of design tools to customize cuts and styles, and then manipulating the images to create the custom designed product. The operation 504 may display the constraints selected by the creator user 108. The constraints may include the kind of the product the recipients user 110 requires, permission for recipient user 110 to customize the product, limited time duration of the gift card 122 and permission given to the recipient user 110 to subdivide the value of the gift card when it is provided by the recipient user 110 to other recipients 112. The operation 506 may display the process of sending the gift card 122 to the recipient user 110 by the creator user 108.

In one embodiment, applying a value (e.g., the value 124 of FIG. 1C) may be applied to the gift card (e.g., the gift card 122 of FIG. 1C) based on a purchase amount of the gift card 122 by the sender. The recipient may be permitted to subdivide a value 124 of the gift card 122 such that other recipients selected by the sender and recipient have an ability to redeem an available balance of the gift card 122 through a purchase of additional ones of the custom merchandise products (e.g., using the desegregation module 220 of FIG. 2).

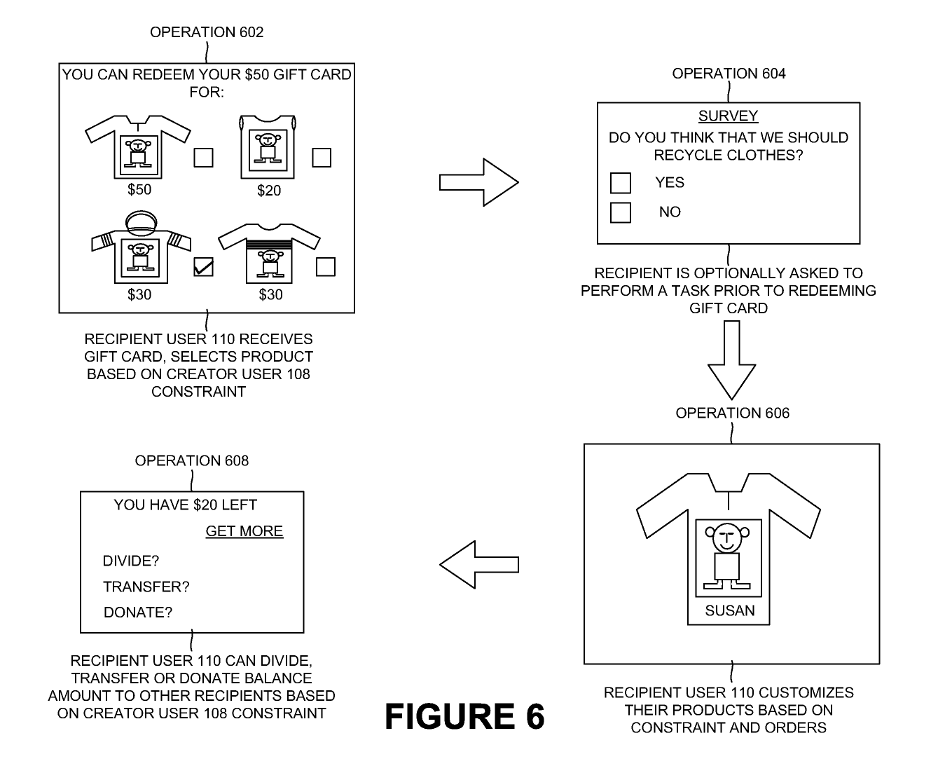

FIG. 6 is a process flow view of managing the value, according to one embodiment. Particularly, FIG. 6 illustrates operation 602, operation 604, operation 606, and operation 608, according to one embodiment.

The operation 602 may display gift card along with the redeemable value sent by the creator user 108 for which the recipient can buy the product of the creator user 108. In operation 602, the recipient user 110 may receive gift card 122 by selecting product based on the creator user 108 constraint. The operation 604 may display a task designed by the creator user 108 for the recipient prior to redeeming the value of the gift card 122.

For example, the task may be a questionnaire response, a survey response, an item purchase, a coupon redemption, etc. In operation 604, the recipient may be required to perform a task if required by the creator user 108 prior to redeeming the gift card 122. In operation 606, the recipient user 110 may customize their products based on constraint and orders. The operation 608 may display the balance value left and provides options like divide, transfer, donate etc. In operation 608, the recipient user 110 may divide, transfer or donate balance value to other participants based on the creator user 108 constraint.

In one embodiment, the recipient user (e.g., the recipient user 110 of FIG. 1A) may be required to perform task (e.g., the task may be a questionnaire response, a survey response, an item purchase, a coupon redemption, etc.) prior to redeeming the value (e.g., the value 124 of FIG. 1C) of the gift card (e.g., the gift card 122 of FIG. 1C). For example, the task is designed by the creator user (e.g., the creator user 108 of FIG. 1A) when providing the gift card 122 to the recipient user 110.

The recipient user 110 may be enabled to apply a required portion of the value 124 of the gift card 122 toward the purchase of the product when a price of the product is less than the value (e.g., the value 124 of FIG. 1C) of the gift card 122. A remaining portion of the value 124 of the gift card 122 may be subdivided among a group of other recipients 112 selected by the recipient user 110 when such a capability is permitted by the creator user 108. The design (e.g., the design 118 of FIG. 1B) may be applied in a representation the gift card 122 such the design 118 is reflected in a communication of the gift card 122 to the recipient.

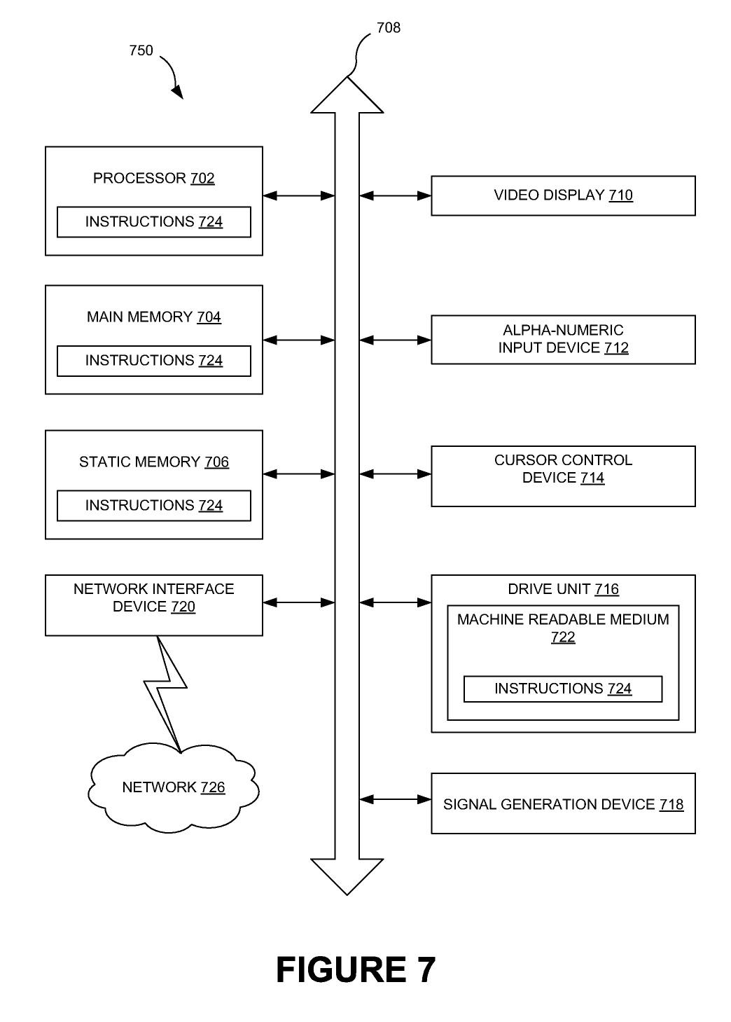

FIG. 7 is a diagrammatic system view 750 of a data processing system in which any of the embodiments disclosed herein may be performed, according to one embodiment. Particularly, the diagrammatic system view 750 of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724 and a network 726, according to one embodiment.

The diagrammatic system view 700 may indicate a personal computer and/or a data processing system in which one or more operations disclosed herein may be performed. The processor 702 may be a microprocessor, a state machine, an application-specific integrated circuit, a field programmable gate array, etc. (e.g., Intel® Pentium® processor). The main memory 704 may be a dynamic random access memory and/or a primary memory of a computer system. The static memory 706 may be a hard drive, a flash drive, and/or other memory information associated with the data processing system.

The bus 708 may be an interconnection between various circuits and/or structures of the data processing system. The video display 710 may provide graphical representation of information on the data processing system. The alpha-numeric input device 712 may be a keypad, a keyboard and/or any other input device of text (e.g., a special device to aid the physically challenged). The cursor control device 714 may be a pointing device such as a mouse.

The drive unit 716 may be the hard drive, a storage system, and/or other longer term storage subsystem. The signal generation device 718 may be a bios and/or a functional operating system of the data processing system. The network interface device 720 may be a device that may perform interface functions such as code conversion, protocol conversion and/or buffering required for communication to and from a network 726.

The machine readable medium 722 may provide instructions on which any of the methods disclosed herein may be performed. The instructions 724 may provide source code and/or data code to the processor 702 to enable any one or more operations disclosed herein.

Although the present embodiments have been described with reference to specific example embodiments, it will be evident that various modifications and changes may be made to these embodiments without departing from the broader spirit and scope of the various embodiments.

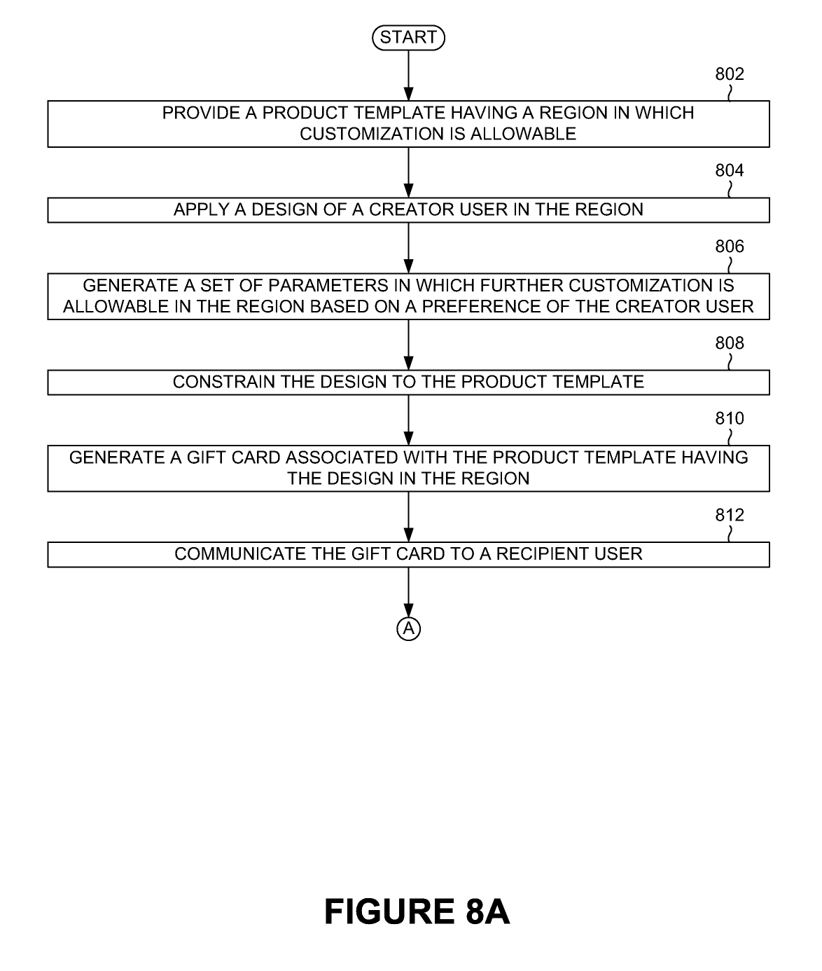

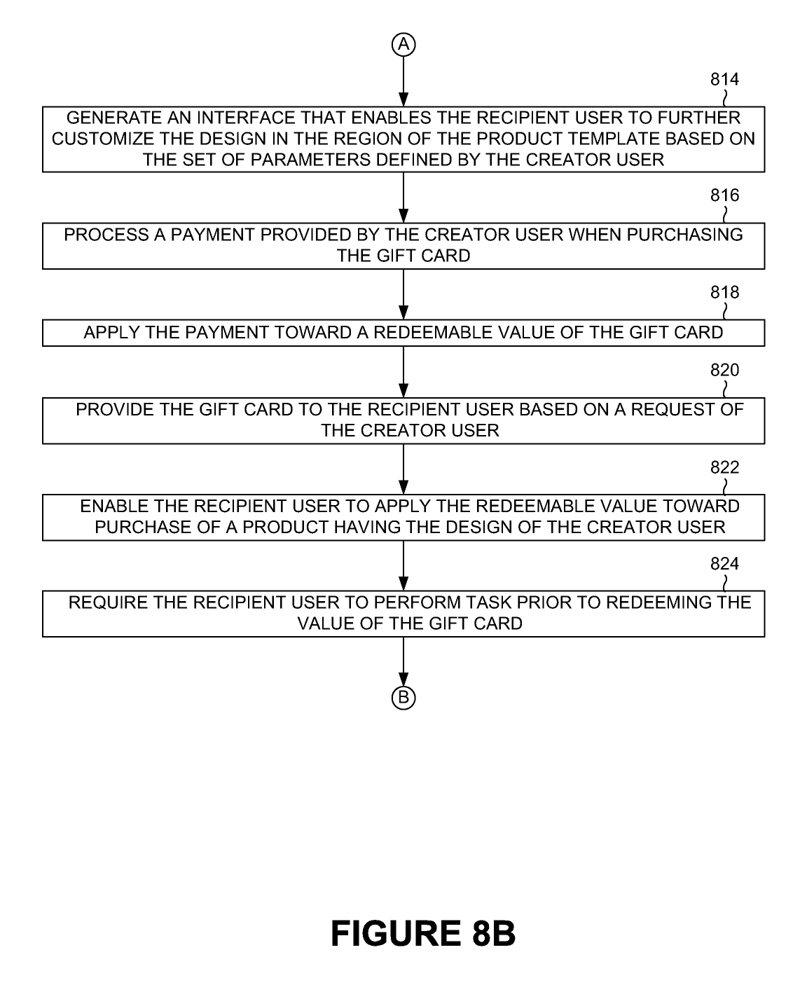

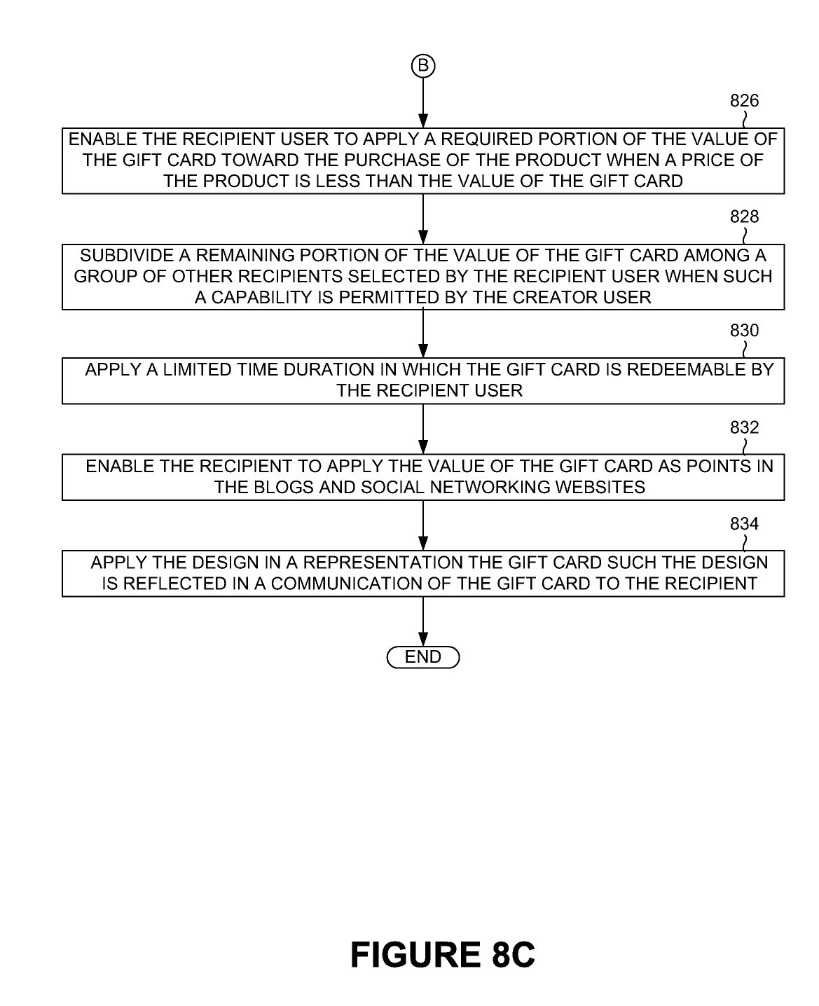

FIG. 8A is a process flow communicating the gift card (e.g., the gift card 122 of FIG. 1C) having a product template (e.g., the product template 114 of FIG. 1B) to a recipient user (e.g., the recipient user 110 of FIG. 1A), according to one embodiment. In operation 802, a product template 114 (e.g., may include an apparel template, a mug template, a t-shirt template, a poster template, a virtual gift template, a postage template, a greeting card template, a calendar template, a button template and/or a print template) may be provided having a region (e.g., the region 116 of FIG. 1B) in which customization is allowable (e.g., as illustrated in FIG. 1B).

In operation 804, a design (e.g., the design 118 of FIG. 1B) of a creator user (e.g., the creator user 108 of FIG. 1A) may be applied in the region 116. In operation 806, a set of parameters (e.g., the set of parameters 120 of FIG. 1B) may be generated in which further customization is allowable in the region 116 based on a preference of the creator user 108 (e.g., as illustrated in FIG. 1B).

For example the set of parameters 120 may include least one of a region 116 surrounding the design 118, a portion of the design 118 itself, and/or a color scheme of the product template 114. In operation 808, the design 118 may be constrained to the product template 114. In operation 810, a gift card 122 associated with the product template 114 may be generated having the design 118 in the region 116 (e.g., as illustrated in FIG. 5). In operation 812, the gift card 122 (e.g., as illustrated in FIG. 1C) may be communicated to a recipient user 110.

FIG. 8B is a continuation of the process flow of FIG. 8A showing additional processes, according to one embodiment. In operation 814, an interface may be generated that enables the recipient user 110 to further customize the design 118 in the region 116 of the product template 114 based on the set of parameters 120 defined by the creator user 108. In operation 816, a payment may be processed provided by the creator user 108 when purchasing the gift card 122.

In operation 818, the payment may be applied toward a redeemable value (e.g., may include shipping and/or handling of the product to a destination defined by the recipient user 110) of the gift card 122. In operation 820, the gift card 122 (e.g., as illustrated in FIG. 1C) may be provided to the recipient user 110 based on a request of the creator user 108. For example, product embodies further customization defined by the recipient user 110 when the further customization adheres to the set of parameters 120 defined by the creator user 108. In operation 822, the recipient user 110 may be enabled to apply (e.g., as illustrated in FIG. 6) the redeemable value toward purchase of a product having the design 118 of the creator user 108.

In operation 824, the recipient user 110 may be required to perform task (e.g., may include a questionnaire response, a survey response, an item purchase, and/or a coupon redemption) prior to redeeming the value (e.g., the value 124 of FIG. 1C) of the gift card (e.g., as illustrated in FIG. 6). For example, the task may designed by the creator user 108 when providing the gift card 122 to the recipient user 110.

FIG. 8C is a continuation of the process flow of FIG. 8B showing additional processes, according to one embodiment. In operation 826, the recipient user 110 may be enabled to apply a required portion of the value 124 of the gift card 122 (e.g., gift card 122 may be distributable as a widget embedded in a plurality of blogs and social networking websites defined by the creator user 108, the recipient user 110 and/or the other recipients 112) toward the purchase of the product when a price of the product is less than the value 124 of the gift card 122 (e.g., as illustrated in FIG. 6).

In operation 828, a remaining portion of the value 124 of the gift card 122 may be subdivided (e.g., as illustrated in FIG. 6) among a group of other recipients 112 selected by the recipient user 110 when such a capability is permitted by the creator user 108. In operation 830, a limited time duration may applied in which the gift card 122 is redeemable by the recipient user 110. In operation 832, the recipient may be enabled to apply the value 124 of the gift card 122 as points in the blogs and social networking websites. In operation 834, the design 118 may be applied in a representation the gift card 122 such the design 118 is reflected in a communication of the gift card 122 to the recipient (e.g., as illustrated in FIG. 5).

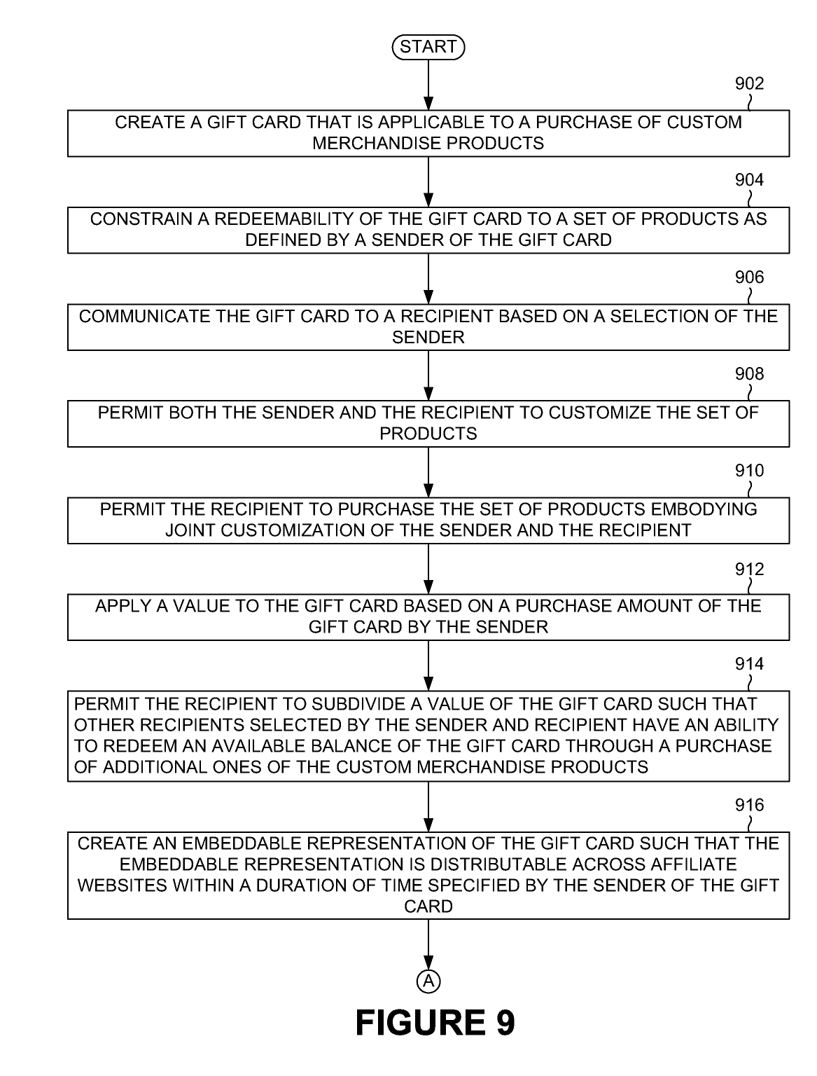

FIG. 9 is a process flow of communicating the gift card (e.g., the gift card 122 of FIG. 1C) having embedded design (e.g., the embedded design 126 of FIG. 1C) and a value (e.g., the value 124 of FIG. 1C) that may be distributable across affiliate websites within a specified duration of time, according to one embodiment. In operation 902, a gift card 122 may be created (e.g., as illustrated in FIG. 5) that is applicable to a purchase of custom merchandise products. In operation 904, a redeemability may be constrained of the gift card 122 to a set of products as defined by a sender of the gift card 122 (using a constraint module 200 of FIG. 2).

In operation 906, the gift card 122 may be communicated to a recipient based on a selection of the sender. In operation 908, both the sender and the recipient may be permitted to customize the set of products. In operation 910, the recipient may be permitted to purchase the set of products embodying joint customization of the sender and the recipient. In operation 912, the value 124 may be applied to the gift card 122 based on a purchase amount of the gift card 122 by the sender. In operation 914, the recipient may be permitted to subdivide the value 124 of the gift card 122 such that other recipients 112 selected by the sender and recipient have an ability to redeem an available balance of the gift card 122 through a purchase of additional ones of the custom merchandise products (e.g., as illustrated to FIG. 5).

In operation 916, an embeddable representation may be created (e.g., as illustrated in FIG. 1C) of the gift card 122 such that the embeddable representation is distributable across affiliate websites within the duration of time specified by the sender of the gift card 122.

For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or Digital Signal Processor (DSP) circuitry).

For example, the gift card module 100, the custom merchandise module 102, the constraint module 200, the product module 202, the finance module 206, the creator constraint module 208, the system constraint module 210, the customizer module 212, the duration module 214, the ship include module 216, the redeem module 218, the disagregation module 220, the purchase module 222, the third party beneficiary module 224, the transfer module 226, the widget module 228 and other modules of FIGS. 1-9 may be enabled using a gift card circuit, a custom merchandise circuit, a constraint circuit, a product circuit, a finance circuit, a creator constraint circuit, a system constraint circuit, a customizer circuit, a duration circuit, a ship include circuit, a redeem circuit, a disagregation circuit, a purchase circuit, a third party beneficiary circuit, a transfer circuit, a widget circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
providing a product template having a region in which customization is allowable;
applying a design of a creator user in the region;
generating a set of parameters in which further customization is allowable in the region based on a preference of the creator user;
constraining the design to the product template;
generating a gift card associated with the product template having the design in the region;
communicating the gift card to a recipient user; and
generating an interface that enables the recipient user to further customize the design in the region of the product template based on the set of parameters defined by the creator user.

2. The method of claim 1 further comprising:
processing a payment provided by the creator user when purchasing the gift card;
applying the payment toward a redeemable value of the gift card;
providing the gift card to the recipient user based on a request of the creator user; and
enabling the recipient user to apply the redeemable value toward purchase of a product having the design of the creator user.

3. The method of claim 2 wherein the product embodies further customization defined by the recipient user when the further customization adheres to the set of parameters defined by the creator user, and wherein the set of parameters include at least one of a region surrounding the design, a portion of the design itself, and a color scheme of the product template.

4. The method of claim 2 wherein the redeemable value includes shipping and handling of the product to a destination defined by the recipient user.

5. The method of claim 2 further comprising requiring the recipient user to perform at least one task prior to redeeming the value of the gift card, wherein the task is designed by the creator user when providing the gift card to the recipient user, and wherein the task is at least of a questionnaire response, a survey response, an item purchase, and a coupon redemption.

6. The method of claim 2 further comprising:
enabling the recipient user to apply a required portion of the value of the gift card toward the purchase of the product when a price of the product is less than the value of the gift card; and
subdividing a remaining portion of the value of the gift card among a group of other recipients selected by the recipient user when such a capability is permitted by the creator user.

7. The method of claim 6 wherein the gift card is distributable as a widget embedded in a plurality of blogs and social networking websites defined by at least one of the creator user, the recipient user, and the other recipients.

8. The method of claim 1 further comprising:
applying a limited time duration in which the gift card is redeemable by the recipient user; and
enabling the recipient to apply the value of the gift card as points in at least one of the plurality of blogs and social networking websites.

9. The method of claim 1 further comprising applying the design in a representation the gift card such the design is reflected in a communication of the gift card to the recipient.

10. The method of claim 1 wherein the product template is at least one of an apparel template, a mug template, a t-shirt template, a poster template, a virtual gift template, a postage template, a greeting card template, a calendar template, a button template, and a print template.

11. The method of claim 1 in a form of a machine-readable medium embodying a set of instructions that, when executed by a machine, causes the machine to perform the method of claim 1.

12. A method comprising:
creating a gift card that is applicable to a purchase of custom merchandise products;
constraining a redeem ability of the gift card to a set of products as defined by a sender of the gift card;
communicating the gift card to a recipient based on a selection of the sender;
permitting both the sender and the recipient to customize the set of products; and
permitting the recipient to purchase at least one of the set of products embodying joint customization of the sender and the recipient.

13. The method of claim 12 wherein customizations defined by the sender take precedence over customizations of the recipient such that customizations by the recipient are constrained by the customizations of the sender.

14. The method of claim 13 further comprising:
applying a value to the gift card based on a purchase amount of the gift card by the sender;
permitting the recipient to subdivide a value of the gift card such that other recipients selected by at least one of the sender and recipient have an ability to redeem an available balance of the gift card through a purchase of additional ones of the custom merchandise products.

15. The method of claim 14 further comprising creating an embeddable representation of the gift card such that the embeddable representation is distributable across a plurality of affiliate websites within a duration of time specified by the sender of the gift card.

16. A system comprising:
a custom merchandise module to generate a set of product templates representing virtual and physical items that are customizable in a region defined in each of the set of product templates;
a gift card module of the custom merchandise module to provide a mechanism such that users of the custom merchandise module provide consideration to other users to procure the virtual and physical items of the custom merchandise module; and
a constraint module of the gift card module to limit a degree in which the other users are permitted to further customize the set of product templates prior to procuring the virtual and physical items represented in the set of product templates.

17. The system of claim 16 further comprising:
a desegregation module of the gift card module to provide an interface such that the other users have an ability to redistribute at least a portion of a value of the gift card to at least one other user, such that users other than the users providing consideration to procure the virtual and physical items through the gift card are constrained in further customization through the constraint module.

18. The system of claim 17 further comprising:
a ship include module of the gift card module to provide a value of transporting the physical items to a physical destination specified by a procuring user as included in the gift card.

19. The system of claim 18 further comprising:
a widget module to distribute the gift card across a plurality of different distribution mediums based on a preference of users sending and receiving the gift card.

20. The system of claim 16 further comprising:
a system constraint module of the constraint module to impose limitations based on at least one of an availability, a stock level, and a lead time of the virtual and physical items.
